(19) United States
(12) Patent Application Publication
(10) Pub. No.: US 2008/0081528 A1
(43) Pub. Date: Apr. 3, 2008

(54) High impact strength, fire resistant woven article

(76) Inventors: H. Landis Carter, Greer, SC (US); Keith Bendyk, Duncan, SC (US); Shobha Murari, Greenville, SC (US)

Correspondence Address: MCNAIR LAW FIRM, P.A., P.O. BOX 10827, GREENVILLE, SC, 29603-0827, US

(21) Appl. No.: 11/904,888

(22) Filed: Sep. 28, 2007

Related U.S. Application Data
(60) Provisional application No. 60/848,167, filed on Sep. 29, 2006.

(51) Int. Cl. D03D 15/00; B32B 38/00; D02G 3/00

(52) U.S. Cl. 442/190; 156/281; 428/364; 442/301

(57) ABSTRACT

A woven article having strands of polyetherimide (PEI) fiber or organic fibers (cyclic polyolefin) and strands of inextensible, heat resistant fiber is disclosed. Preferably warp and weft fibers of PEI are provided wherein said fibers bond together when heated. By using a multiplicity of PEI fibers, heating and compressing the woven article will produce a sheet-like surface on at least one side thereof.

### CROSS REFERENCE TO RELATED APPLICATION

This application claims priority of provisional application Ser. No. 60/848,167 filed Sep. 29, 2006.

### FIELD OF THE INVENTION

This invention relates generally to single layer, multi-layer fabrics and dual-layer Conform Fabric®. More specifically, the invention relates to fabrics having polyetherimide fibers, or combinations of polyetherimide fibers with polymeric, mineral, or metal fibers or polymeric fibers such as ultra high molecular weight polyethylene fibers and to rigid and semi-rigid articles that may be formed from said fabrics.

### BACKGROUND OF THE INVENTION

The desirable properties of polyetherimide are well-known and among these are that it has high strength and good chemical, heat and flame resistance. Generally, the use of polyetherimides (PEI) has been for applications such as injection molding processes that produce a large variety of high heat resistant articles. Perhaps the most widely known and developed polyetherimide resins are the ULTEM® resins of General Electric Company. Other well-known high strength fibers are the Innegra™ thermoplastic fibers from Innegrity, LLC of Greenville, S.C. some of which are described in Innegrity's U.S. Pat. No. 7,074,483 and in their patent publication cited therein. There fibers or yarns are designated “cyclic polyolefin” or organic yarns herein.

One process for making polyetherimide fibers is described in U.S. Pat. No. 4,943,481 which issued on Jul. 24, 1990 to Diederich Schilo, et al. and is assigned to Akzo N. V. Recently, in an article entitled “New GE Ultem Fiber Offers Compliance With All Flame-Retardancy Regulations” published in the International Fiber Journal in March of 2006 a new polyetherimide fiber was described. The high strength, high-heat resistance and broad chemical resistance of Ultem fiber are reported in the article including its high glass transition temperature of 217° C. In addition, it is an amorphous material with melt temperature in the range of 375° F. to 400° F. While the fiber was developed as a flame retardant material for mattress covers, it has many applications in home furnishings, gas filtration, transportation fabrics, and textiles generally and especially for fabrics in seating applications. Accordingly, a general object of the present invention is to provide unique products from the aforementioned fibers and yarns. These products will be better understood by reference to the summary of the invention below.

Another object of the present invention is to provide a woven fabric with a thermoplastic resin in it which eliminates the pre-preg process in the manufacture of a composite. This reduces the volatile organic compounds used in the manufacture of composites such as the use of Ultem liquid resin systems in the manufacture of printed circuit boards.

In the prior art, in the manufacture of, for example, carbon reinforced plastic parts, usually composite parts of this type are made by layering sheets of carbon fiber cloth into a mold in the shape of the desired product and the mold filed with epoxy then heated and cured. Circuit boards among other products may be made in this manner. Composite parts are also made by draping a carbon cloth that is pre-impregnated (pre-preg) with epoxy over a mold, heated and cured whereby the pre-preg assumes the shape of the mold. Accordingly, a further object of the invention is to provide a composite reinforced part that does not require the pre-impregnation with epoxy or the filling of a mold with epoxy.

### SUMMARY OF THE INVENTION

In one aspect the present invention is a novel woven article having at least one yarn strand comprising a high Tg amorphous polyetherimide (PEI); and at least one yarn strand of a heat resistant and inextensible, dimensionally stable material. In one embodiment all weft yarns may be PEI. In another embodiment all warp yarns may be PEI, and in another embodiment both weft and warp yarns comprise PEI. In either of these embodiments the PEI may be heated to flow and bond with parallel PEI yarns.

In another aspect, the fabric may have at least one PEI strand that is a warp yarn and includes at least one PEI strand as a weft yarn, said PEI strands being heat bonded to each other at their intersections. It is preferred that the woven article comprise at least 10% by weight of PEI yarns, and up to 65% of the yarns may be PEI.

In another aspect, the dimensionally stable material may be selected from the group consisting of mineral, carbon, or polymer fibers having limited extensibility such as the thermoplastic Innegra™ yarn. The woven article may be single ply or multi-ply or the Conform Fabric® product that is described and claimed in U.S. Pat. No. 5,102,725 to Martha Knox, et al. on Apr. 7, 1992. The teachings of the aforesaid patent are incorporated herein by reference.

In still a further aspect, the present invention is a method of making a woven article comprising the steps of weaving a fabric having at least one weft and at least one warp yarn which comprises PEI, total weight of the PEI in the fabric being at least 10% and heating said fabric to cause the PEI strands to flow and bond to each other at their intersections. In this method, warp and weft yarns may be selected from the group consisting of mineral, polymeric, metal or carbon fibers. In an additional aspect, the foregoing method may include a step for the application of heat to at least one side of said fabric and the fabric is heated until the PEI strands flow together and form a sheet-like face on one side of the fabric. This can be accomplished by applying a heated plate to the fabric wherein the plate has a non-stick surface. In this aspect, two or more sheets of fabric may be stacked one on top of the other in layers, pressed and heated whereby the PEI flows to adjacent layers to form a composite article. The sheets may be of different yarn compositions and may be oriented in different directions, that is, the warp yarns in one layer may be at right angles to the warp yarns in an adjacent layer or may be at a 45° angle or at another angle. Articles so produced can eliminate the need for pre-impregnating or reinforcing fabric with a molding resin.

In another aspect, the heating step mentioned above may be performed by passing the fabric through the nip of heated rollers, in a calendaring process or placed in a heated press or placed in an autoclave, or oven or another alternative heating device.

In addition to forming a multi-layer article as described above the invention also includes the step of adhering or bonding the article to a metal, or metallic, ceramic, or cement surface.

Yet in another aspect of the invention, a unique sizing is provided for the PEI yarn so that it may be readily woven with fiberglass or mineral yarns, such sizing comprising and amine polymer, polyvinyl alcohol and a coupling agent.

A still further aspect of the present invention includes the preparation of a yarn by wrapping strands of PEI or an organic polymeric yarn around quartz or fiber glass strands to provide a wrapped yarn.

The foregoing and other aspects of the present invention will be better understood by reference to the accompanying drawings and detailed description which follow.

### DESCRIPTION OF THE DRAWINGS

The drawings which are appended hereto and made a part of this disclosure are provided by way of illustration and not by way of limitation. In the drawings:

FIG. 1 is a perspective schematic representation of one embodiment of a woven article according to the present invention;

FIG. 2 is a schematic representation of a woven article which is another embodiment of the present invention; and,

FIG. 3. is an embodiment of a woven article of the present invention showing the article in cross-section after the application of heat to an article similar to that shown in FIG. 2.

FIG. 4 is a schematic representation of a sectional side view of one embodiment of the invention which is a multi-layer article;

FIG. 5 is a perspective view of a wrapped yarn which is another embodiment of the invention;

FIG. 6 is a schematic representation of a woven article of the invention positioned in a heated press for the application of heat and pressure; and

FIG. 7 represents a stack of woven articles according to the invention ready to be pressed together.

### DETAILED DESCRIPTION

Turning first to FIG. 1, a woven article, namely fabric 1 is shown in schematic perspective. In the longitudinal or warp direction warp threads 3 are shown which preferably comprise a polyetherimide (PEI) fiber which is the ULTEM® fiber supplied by General Electric Company and are selected from PEI formulations designated ULTEM® 1000, 1000 D, 1010, or 9011. Other warp fibers or yarns such as yarn 4 may be an inextensible or relatively inextensible yarn to give the fabric added dimensional stability. The yarn 4 may be mineral based comprising quartz, fiberglass or basalt, or it may be carbon, a metal or metal alloy, or a polymeric material having inextensible and heat resistance properties. In the weft or fill direction fibers 2 are also PEI fibers. These may be accompanied by weft inextensible fiber 5. In addition, other yarns may be optionally added to the fabric such as weft yarn 8, and warp yarn 9. These added or additional yarns may be polymeric, metal, or mineral and are used to impart desired properties to the woven article.

The woven article of FIG. 1 may have only warp yarn 3 which comprise PEI and the weft yarns may be of another material. Likewise, the warp yarns may be of a material other than PEI and the weft yarns may be PEI. Preferably, a minimum of 10% of PEI yarns should be included in the article and up to 65% or more may be included. It is desirable to have a relatively inextensible yarn woven into the article to provide dimensionally stability. In addition, the woven article may be of single-ply, multi-ply, or a Conform Fabric®; and any weave pattern may be used such as satin, twill, plain, crowfoot or similar pattern.

If a Conform Fabric® product is desired, the fabric may be first shaped into the desired geometric configuration and then heat applied which will cause the intersections of PEI strands 2 and 3 to bond at an intersection 7 as illustrated in FIG. 1. This tends to lock the fabric into its desired three-dimensional shape.

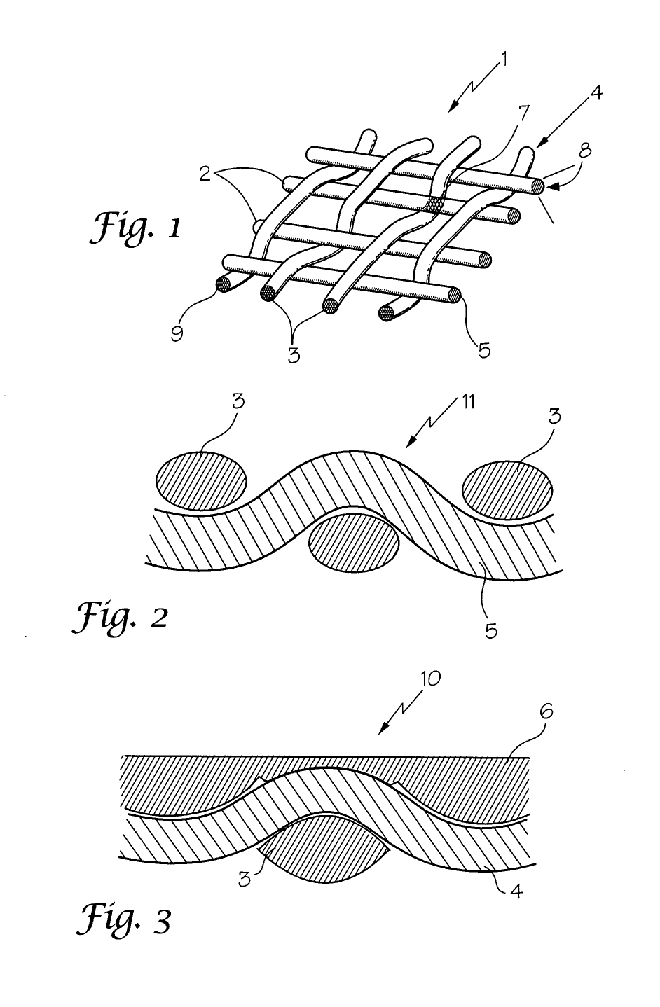

Looking now at FIG. 2, a schematic representation of a woven article 11 is shown in cross section, having warp threads 3 of PEI and a weft 5 of an inextensible fiber such as quartz or fiberglass. To a configuration such as this, heat is applied by pressing a heated plate against fabric 11 until the PEI becomes soft and flows. This will occur at or above the glass transition temperature as the melt temperature range is approached. As an alternate way of applying heat, the fabric 11 can be passed through the nip of heated rollers or a press or oven or autoclave or an alternative heating device. The result will appear as shown in FIG. 3 where the PEI yarns 3 have melted and have flowed together to form the sheet-like planar surface 6 which, upon cooling, becomes a semi-rigid to rigid surface. By varying the yarn density of PEI more or less sheet material 6 can be produced. FIG. 3 represents a preferred embodiment and a best mode of carrying out the invention.

The woven article 10 with the sheet-like PEI surface has remarkable toughness and impact resistance being able to withstand the impact of small to medium caliber projectiles and making it a desirable material for protective garments. Another application for the product due to its high frequency insulation properties is in aerospace components and in microwave communications. Other applications are for ballistic protection and for filtration applications.

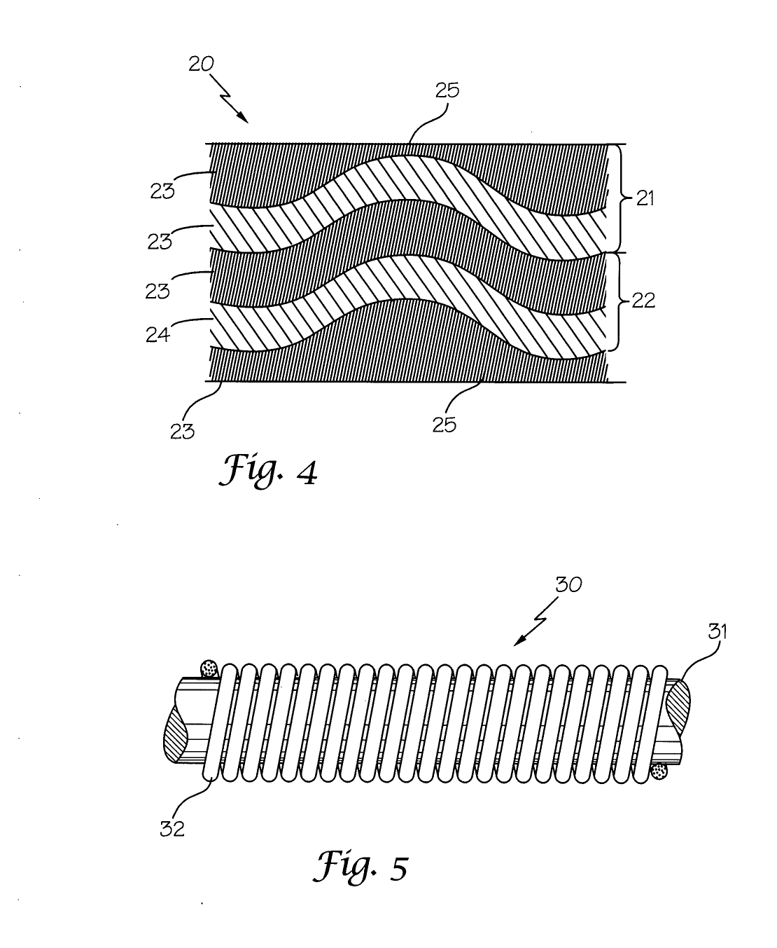

Turning now to FIG. 4, an alternate embodiment 20 is shown where two layers 21, 22 or sheets of fabric have been positioned over each other before heat is applied. This is accomplished by taking sheets of fabric 11 as shown in FIG. 2 and applying heat to achieve a multi-layer structure of the article 10 of FIG. 3.

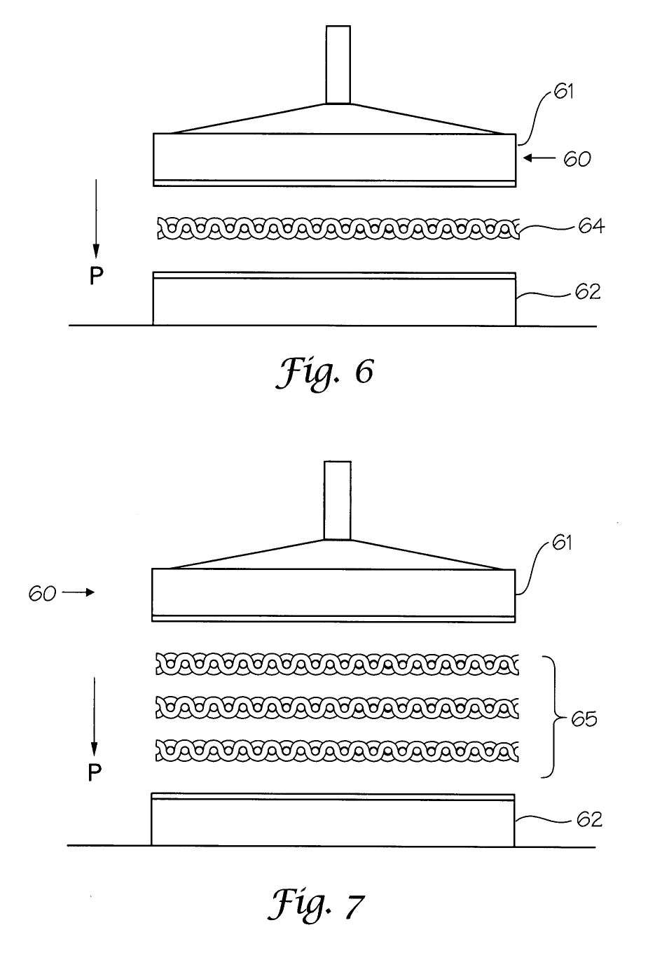

FIG. 6 shows a representative mold 60 having a movable pressure plate 61 which is heated and can compress a woven article 64 against stationary bottom heated plate 62 to produce a pressed article 10.

A preferred method of making article 20 is to stack sheets of the types shown in FIGS. 1 and 2 in the manner shown in FIG. 7 to form stack 65 in a mold 60, and apply pressure and heat until the PEI strands 23 flow and join together as shown. The sheets may be stacked with warp yarns in the same direction, at right angles to each other, at 45° degree angles or other angular orientation. Each layer may have a different yarn make-up, that is, one layer may comprise PEI and quartz warp and weft yarns while the next or superposed layer of fabric may comprise PEI yarn and Innegra™ polyolefin yarn, that is, quartz, fiberglass, carbon, metal or Innegra™ strands may be strands 24. Each layer of fabric is chosen to impart desired characteristics to the composite, finished article. The significant feature is that a polymeric material having the desirable properties of PEI fiber or is a PET fiber, is used in each fabric layer. The faces 25 may be used as the outer surface of the article or the article may be adhered to another surface.

The embodiments of FIGS. 3 and 4 have many unique uses and applications and provide novel and useful articles. For example, circuit boards may be made according to the FIG. 4 embodiment and used directly eliminating the preparation step. An Ultemate Armor™ product for blast protection may be also produced. The products of this invention have the advantages of relatively low cost, low weight, corrosion resistance, flexibility and high impact resistance.

In a first example which is one best mode of the invention which employs 75 denier Ultem 100 D yarn as the fill and is identified as applicants' style 15382, an 8H Salem weave fabric with a 60×104 construction having a thickness 0.0208,″ and a weight of 15.97 oz/sq. yd. had a warp tensile strength of 545 lbs/sq. in. and a tensile fill strength of 605 lbs/sq. in. The warp is 75 denier fiberglass.

In a second example using 150 denier, cyclic polyolefin Innegra™ yarn as the fill, identified as applicants' style 15400 a fabric; a fabric having plain weave with a 60×46 construction with a thickness of 0.00392″ had a weight of 1.72 oz/sq. yd., a warp tensile strength of 147.9 lbs/sq. in., and a fill tensile strength of 30.6 lbs/sq. in. The warp yarn is fiberglass.

The fabrics of Examples 1 and 2 above may be stacked and pressed as described for FIGS. 6 and 7 to provide reinforced articles such as shown in FIGS. 3 and 4. The need to carefully position reinforcing sheets of carbon fiber or fiberglass in a mold and then pour in a molding resin such as epoxy is not required to produce a product such as a circuit board or other articles.

Another alternate and preferred embodiment of the invention is a wrapped yarn or composite fiber. Such a fiber is described in U.S. Pat. No. 6,127,035 which issued on Oct. 3, 2000 and which is incorporated herein by reference. Looking now at FIG. 5, composite fiber 30 is shown having a core 31 of a mineral fiber, preferably quartz or fiberglass, wrapped with PEI strands 32. This is a versatile, high strength composite fiber which can be used in the weaving of fabrics as described above. This composite fiber, being wrapped with PEI, readily bonds to adjacent PEI fibers under heat and pressure to form very strong woven articles.

As mentioned above, the thermoplastic fibers that may be used in this invention are useful for their chemical inertness, heat and flame resistance and dimensional stability. Among these are fibers of quartz, fiberglass including E, S, and S-2, and basalt. Carbon fibers are also of this type and may readily be used. Metal fibers that are of particular usefulness are those of copper, aluminum, nickel, gold, and platinum, and alloys including steel and bronze. The fibers of useful polymeric materials include Kevlar® aramid, polypropylene, and the ultra high molecular weight polyethylene fiber Innegra™.

The woven fabric of this invention is especially useful as reinforcing matrices in structures formed with epoxy resins such as those described in U.S. Pat. No. 6,720,080 to Murari, et al. which is incorporated herein by reference. In addition, finish can be applied such as those described in U.S. Pat. No. 6,036,735 to Carter, et al. which also is incorporated herein by reference.

While preferred embodiments of the invention have been described using specific terms, such description is for illustrative purposes only as it will be understood that upon reading the foregoing disclosure modifications and alterations may become apparent to those skilled in the art. but our invention is limited only by the scope of the claims which follow.

What is claimed is:

1. A woven article comprising:
1) at least one strand comprising a yarn selected from the group consisting of high glass transition temperature (Tg) amorphous polyetherimides (PEI) yarn and cyclic polyolefin yarns; and
2) at least one yarn strand of a heat resistant, inextensible, dimensionally stable material.

2. The woven article of claim 1 wherein said PEI strand is a warp yarn and including at least one PEI strand as a weft yarn, said PEI strands being heat bonded to each other at their intersections.

3. The woven article of claim 1 wherein at least 10% of the yarns in the woven article are PEI yarn.

4. The woven article of claim 1 wherein up to 65% of the yarns are PEI.

5. The woven article of claim 1 wherein the inextensible material is selected from the group consisting of quartz, glass, basalt, metal, and carbon fibers.

6. The woven article of claim 1 wherein the article is a multi-ply article.

7. The woven article of claim 1 wherein the article is a shaped fabric having a three-dimensional configuration.

8. The woven article of claim 1 wherein the warp yarn is fiberglass and the weft yarn is PEI.

9. The woven article of claim 1 wherein the warp yarn is fiberglass and the weft yarn is a cyclic polyolefin.

10. A method of making a woven article comprising the steps of:
a) weaving a fabric having either a weft or warp yarn comprising a fiber selected from the group consisting of PEI and cyclic polyolefin fiber, the total weight of the PEI or cyclic polyolefin in the fabric being at least 10%; and,
b) heating said fabric to cause the PEI strands or cyclic polyolefin fibers to flow and bond to each other.

11. The method of claim 10 including warp and weft yarns selected from the group consisting of quartz, glass, basalt, metal, carbon fibers or organic polymer fibers.

12. The method of claim 10 wherein the weft yarns are PEI and including the steps of applying pressure and further heating at least one side of said fabric until the PEI strands flow together and form a sheet-like face on one side of said fabric.

13. The method of claim 12 wherein the heating step is performed by the application of a heated plate.

14. The method of claim 12 wherein the heating step is performed by passing the fabric between heated rollers or alternative heating devices.

15. The method of claim 12 including the step of weaving a multiplicity of sheets said fabric and stacking sheet in a mold prior to the heating step b).

16. The method of claim 12 wherein in the stacking step, the sheets have a different orientation of warp yarns.

17. The method of claim 15 wherein the sheets have different fiber compositions.

18. The product of the method of claim 10.

19. The product of the method of claim 12.

20. The product of the method of claim 15.

21. A composite yarn comprising a core of a mineral fiber with a yarn of PEI fiber or cyclic polyolefin fiber wrapper around said core.

22. A fabric woven with the yarn of claim 21.
